(19) United States
(12) Patent Application Publication
(10) Pub. No.: US 2006/0289249 A1
(43) Pub. Date: Dec. 28, 2006

(54) Sliding cylinder bore caliper assembly

(76) Inventors: Seiji Nishimura, West Bloomfield, MI (US); Sean C. Barrett, Farmington Hills, MI (US)

Correspondence Address: HARNESS, DICKEY & PIERCE, P.L.C., P.O. BOX 828, BLOOMFIELD HILLS, MI, 48303, US

(21) Appl. No.: 11/159,058

(22) Filed: Jun. 22, 2005

(51) Int. Cl. F16D 55/18

(52) U.S. Cl. 188/72.4; 188/370

(57) ABSTRACT

A brake caliper assembly includes a caliper body with a support portion and a force applying portion. A pair of brake pads is slidably coupled with the caliper body. The force applying portion has a first cylinder adapted to be fixed to a vehicle to enable the support portion to slide with respect to the first cylinder. A second cylinder is slidably positioned within a bore of the first cylinder. A piston is positioned within a bore of the second cylinder and is movable with respect to the second cylinder to apply a force onto the brake pads.

### FIELD OF THE INVENTION

The present invention relates to brake calipers and, more particular, to a brake caliper including a sliding bore cylinder mated with a sliding piston

### BACKGROUND OF THE INVENTION

Caliper assemblies have existed in the art for many years. Generally, a caliper assembly includes a cast caliper body coupled with a cast support bracket. Brake pads are slidably hung on the support bracket and associated with the caliper body. A piston mechanism is seated within the caliper body to apply force onto the brake pads in order to brake or stop a rotor. The caliper body, as well as the support bracket, are ordinarily casted from molten iron. The castings, after they are molded, then require surface finishing such as burnishing, boring, cutting or the like to ready the cast caliper body and bracket for use. The casting, as well as the machining, adds to the weight and cost to manufacturing the caliper assembly.

While these calipers work well for their intended purpose, engineers and designers always strive to reduce costs as well as weight associated with the caliper. Thus, it would be desirable to manufacture a caliper assembly, which reduce the weight of the caliper assembly, as well as reduces the cost involved with manufacturing the caliper assembly.

### SUMMARY OF THE INVENTION

The present invention provides the art with a caliper assembly which enables a sliding cylinder to be mated with a sliding piston. This combination enables the caliper components to be stamped or cold formed. The stamping and cold forming of the caliper brake parts reduces costs. Also, utilizing stamped and cold form parts reduces the machining requirements which are required in the cast iron parts which, in turn, reduces the cost of the caliper assembly. Also, the present invention reduces the weight of the caliper assembly. The present invention also provides for a caliper which enables flexible design changes to compensate for rotor thickness as well as cylinder size.

According to the present invention, a brake caliper comprises a support member to support brake pads to brake or stop a rotor. A caliper body is coupled with the support member. The caliper body includes a first cylinder fixed with respect to the support member. The first cylinder has a central bore which receives a second cylinder. The second cylinder is slidable in the first cylinder bore. Also, the second cylinder includes a second central bore. A piston, to apply a force onto the brake pads, is slidably received in the second central bore. Further, the support member may be fixedly coupled with the caliper body. Sealing members are coupled with the first cylinder and second cylinder as well as with the first cylinder and the piston. The support member may be stamped as a yoke. Also, the second cylinder includes grooves to retain ring sealing members.

In accordance with a second aspect of the invention, a brake caliper assembly comprises a caliper body with a support portion and a force applying portion. A pair of brake pads is slidably coupled with the caliper body. The force applying portion further comprises a first cylinder fixed with respect to the support member. The first cylinder has a central bore which receives a second cylinder. The second cylinder is slidable in the first cylinder bore. Also, the second cylinder includes a second central bore. A piston, to apply a force onto the brake pads, is slidably received in the second central bore. Sealing members are coupled with the first cylinder and second cylinder as well as with the first cylinder and the piston. The support member may be stamped as a yoke. Also, the second cylinder includes grooves to retain sealing ring members. Also, one of the brake pads may have a surface area larger than the other. The second cylinder may be fixed on a connecting plate. Further, pins slidably connect the connecting pads with the brake pads.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a caliper assembly in accordance with present invention;

FIG. 2 is a cross sectional view of FIG. 1 along line 2-2 thereof;

FIG. 3 is a perspective view of an additional embodiment of the present invention; and

FIG. 4 is a cross-section view of Figure taken along line 4-4 thereof.

### DETAILED DESCRIPTION OF THE PREFERRED EMBODIMENTS

The following description of the preferred embodiment(s) is merely exemplary in nature and is in no way intended to limit the invention, its application, or uses.

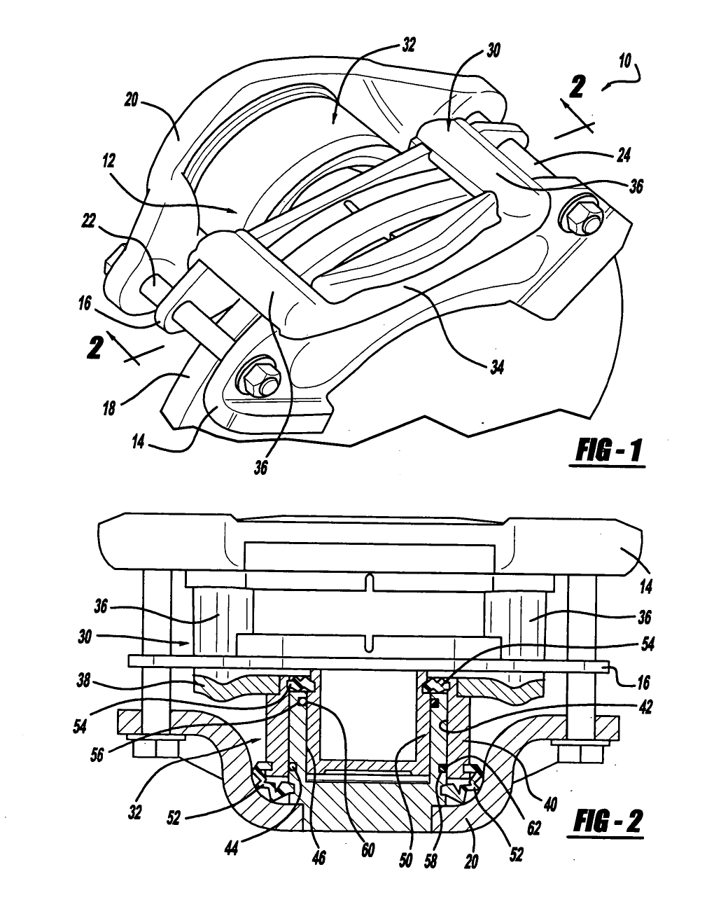

Turning to the figures, FIG. 1 illustrates a caliper assembly which is designated with the reference numeral 10. The caliper assembly 10 includes a caliper body 12, a pair of brake pads 14 and 16 sandwiching a rotor 18. A connecting plate 20 is coupled with the caliper body 12 and includes pins 22 and 24. The pins 22 and 24 extend through bores in the brake pads 14 and 16.

The caliper body 12 includes a support portion 30 and a force applying portion 32. The support portion 30 has a first leg 34 which is coupled with the brake pad 14 to maintain the brake pad on the assembly. Two bridge members 36 connect the leg member 34 to a wall member 38. The wall member 38 is coupled with the force applying portion 32. The support portion 30 has an overall rectangular configuration which straddles the rotor 18. The wall member 38 includes an aperture coupling it with the force applying portion 32.

The force applying portion 32 includes a first cylindrical member 40 which is secured with the wall 38. The cylindrical member 40 has a central bore 42. The cylindrical member 40 is secured to a vehicle knuckle (not shown) to fix the caliper onto a vehicle. A second cylindrical member 44 is slidably received in the central bore. The second cylindrical member 44 also includes a second central bore 46. The second cylindrical member 44 may be secured with a connecting plate or an additional portion of the caliper body.

A piston 50 is slidably received in the second cylindrical bore 46. The piston 50 applies a force onto the brake pad 16 in a conventional manner.

Sealing members 52 and 54 are connected between the first cylinder member 40 and the second cylinder member 44 and the first cylinder member 40 and the piston 50, respectively. The sealing members 52, 54 seal the assembly against dirt or the like from entering into the first applying portion of the body.

The second cylindrical member 44 also includes grooves 56, 58 on its external and internal surface to receive sealing or elastomeric members 60, 62 to seal and balance the piston and the second cylinder member 44 and the first cylinder member 40.

The connecting plate 20 is fixed with the second cylinder member 44. The second cylinder member 44 is slidably connected to the pins 22 and 24. The connecting plate 20 acts as the backing member of the caliper body.

The caliper assembly functions as follows. With the first cylinder member 40 attached to a knuckle (not shown), the caliper assembly is mounted on a vehicle. A hydraulic pressure enters the second central chamber 46 exerting a force onto the piston 50. As the piston 50 moves forward, the brake pad 16 moves toward the rotor 18 to apply a force onto the rotor. At the same time, the hydraulic pressure exerts a force in the reverse direction onto the second cylinder member 44. As this occurs, since the first cylinder 40 is fixed, the second cylinder 44 moves away from the rotor 18 which, in turn, forces brake pad 14 against the other side of the rotor 18. Thus, effective braking occurs. Accordingly, it is possible to maintain a closer fit clearance between the sliding cylinder and the pistons than in traditional slide pins. Also, the bearing area used to react brake torque and road loads is greater than the area available using traditional slide pins.

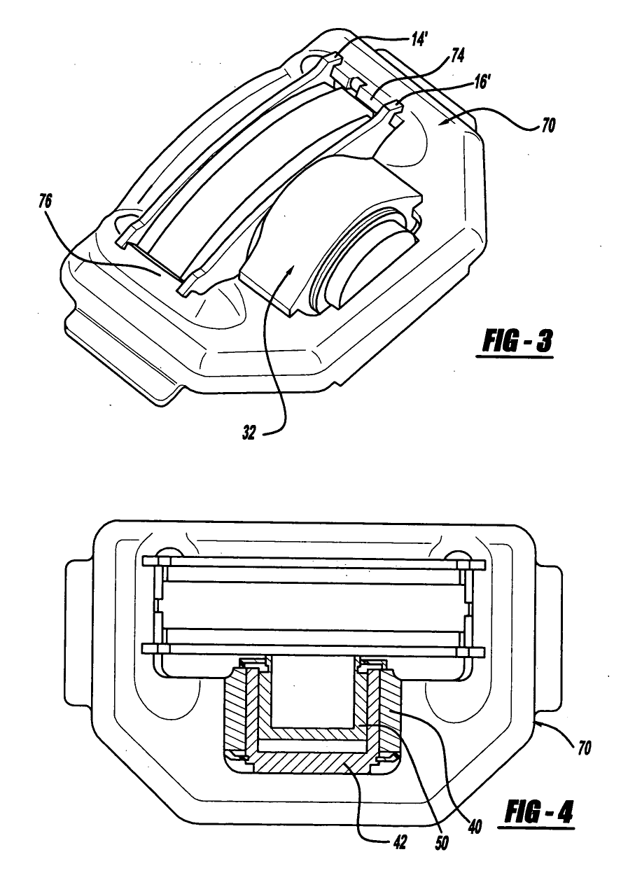

Moving to FIGS. 3 and 4, an additional embodiment of the present invention is shown. Here, the caliper body is shown as part of a stamped yoke. The brake members 14′ and 16′ are positioned in the opening in the yoke member 70 and slide along the rails 74 and 76. The force applying portion 32 is the same as previously described. The yoke 70 slides along the first cylinder 40. The second cylinder 42 is secured to the yoke member. The caliper assembly functions substantially the same as that described above.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A brake caliper comprising:
a support member supporting brake pads for braking a rotor;
a caliper body, said caliper body coupled with said support member, said caliper body including a first cylinder adapted to be fixed on a vehicle and enabling said support member, to move with respect to said first cylinder, said first cylinder having a first central bore,
a second cylinder positioned in said first central bore, said second cylinder movable in said first central bore, said second cylinder including a second central bore; and
a piston member for applying a force onto the brake pads, said piston member movable in said second central bore with respect to said second cylinder.

2. The brake caliper according to claim 1 wherein said support member is fixably coupled with said caliper body.

3. The brake caliper according to claim 1 wherein a sealing member is coupled with said first cylinder and said second cylinder.

4. The brake caliper according to claim 3 wherein a second sealing member is coupled between said first cylinder and said piston member.

5. The brake caliper according to claim 4 wherein said support member being a stamped yoke.

6. The brake caliper according to claim 4 wherein said second cylinder includes a first groove on an exterior surface and a second groove in a surface of the central bore.

7. The brake caliper according to claim 6 wherein ring seals are positioned in said grooves.

8. A brake caliper assembly comprising:
a caliper body having a support portion and a force applying portion,
a pair of brake pads slidably coupled with said caliper body,
said force applying portion further comprising a first cylinder adapted to be fixed on a vehicle and enabling said support member to move with respect to said first cylinder, said first cylinder having a first central bore;
a second cylinder positioned in said first central bore, said second cylinder movable in said first central bore, said second cylinder including a second central bore; and
a piston member movable in said second central bore with respect to said second cylinders for applying a force on said brake pad.

9. The brake caliper according to claim 8 wherein said support member is fixably coupled with said caliper body.

10. The brake caliper according to claim 8 wherein a sealing member is coupled with said first cylinder and said second cylinder.

11. The brake caliper according to claim 10 wherein a second sealing member is coupled between said first cylinder and said piston member.

12. The brake caliper according to claim 11 wherein said support member being a stamped yoke.

13. The brake caliper according to claim 11 wherein said second cylinder includes a first groove on an exterior surface and a second groove in a surface of the central bore.

14. The brake caliper according to claim 13 wherein ring seals are positioned in said grooves.

15. The brake caliper assembly according to claim 8 wherein one of said brake pads has a surface area larger than the other.

16. The brake caliper assembly according to claim 8 wherein said second cylinder is fixed on a connecting plate.

17. The brake caliper assembly according to claim 16 wherein pins connect said connecting plate with said brake pads.

18. The brake caliper assembly according to claim 17 wherein said connecting plate and brake pads are slidable on said pins.
